(19) United States
(12) Patent Application Publication
(10) Pub. No.: US 2024/0413509 A1
(43) Pub. Date: Dec. 12, 2024

(54) SYSTEMS AND METHODS FOR DRAINING FLUIDS FROM TRACTION BATTERY PACKS

(71) Applicant: FORD GLOBAL TECHNOLOGIES, LLC, Dearborn, MI (US)

(72) Inventors: Shuya Shark YAMADA, Novi, MI (US); Junho KIM, Detroit, MI (US); Blaise CORSO, Berkley, MI (US)

(21) Appl. No.: 18/332,908

(22) Filed: Jun. 12, 2023

(51) Int. Cl. H01M 50/691; H01M 50/204

(52) U.S. Cl. CPC H01M 50/691; H01M 50/204; H01M 2220/20

(57) ABSTRACT

Systems and methods are provided for draining fluids (e.g., water and/or other fluids) from a traction battery pack. An exemplary water drainage system for a traction battery pack may include one or more drainage tubes. Each drainage tube may be configured to release water from the tube in response to forces that naturally occur while driving an electrified vehicle that is equipped with the traction battery pack. Water may enter the drainage tubes through a drain provided in an enclosure tray of the traction battery pack.

### TECHNICAL FIELD

This disclosure relates generally to electrified vehicle traction battery packs, and more particularly to removing fluids (e.g., water) that can accumulate inside the traction battery pack.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, an enclosure assembly including an enclosure cover and an enclosure tray that cooperate to establish an interior, a battery array positioned within the interior, and a water drainage system including a first drainage tube mounted to or formed as part of the enclosure tray. The first drainage tube is configured to drain a fluid from the interior to a location outside of the traction battery pack.

In a further non-limiting embodiment of the foregoing traction battery pack, the fluid includes water.

In a further non-limiting embodiment of either of the foregoing traction battery packs, the first drainage tube is configured to interface with the interior via a drain provided within a floor of the enclosure tray.

In a further non-limiting embodiment of any of the foregoing traction battery packs, the drain includes at least one hole formed through the floor.

In a further non-limiting embodiment of any of the foregoing traction battery packs, the first drainage tube includes at least one opening that aligns with the at least one hole to allow the fluid to drain into the first drainage tube.

In a further non-limiting embodiment of any of the foregoing traction battery packs, the first drainage tube includes an first inlet check valve, a first outlet check valve, and a first tubular body extending between the first inlet check valve and the first outlet check valve.

In a further non-limiting embodiment of any of the foregoing traction battery packs, a second drainage tube is mounted to or formed within the enclosure tray and includes a second inlet check valve, a second outlet check valve, and a second tubular body extending between the second inlet check valve and the second outlet check valve.

In a further non-limiting embodiment of any of the foregoing traction battery packs, the first drainage tube and the second drainage tube are arranged such that the first outlet check valve and the second outlet check valve are positioned near opposite ends or sides of the enclosure tray.

In a further non-limiting embodiment of any of the foregoing traction battery packs, the first drainage tube and the second drainage tube are arranged such that the first outlet check valve and the second outlet check valve are positioned near a common end or side of the enclosure tray.

In a further non-limiting embodiment of any of the foregoing traction battery packs, the first outlet check valve is a flapper valve.

In a further non-limiting embodiment of any of the foregoing traction battery packs, the first outlet check valve is a spring valve.

In a further non-limiting embodiment of any of the foregoing traction battery packs, the first outlet check valve is a spring-ball valve.

In a further non-limiting embodiment of any of the foregoing traction battery packs, the first drainage tube is configured to expel the fluid to the location outside of the traction battery pack in response to a force associated with a velocity change.

An electrified vehicle according to another exemplary aspect of the present disclosure includes, among other things, an underbody including a first frame rail and a second frame rail, a traction battery pack mounted between the first frame rail and the second frame rail and including an enclosure assembly that establishes an interior, a first drainage tube arranged at an exterior surface of the enclosure assembly, and a second drainage tube arranged at the exterior surface. The first drainage tube is configured to expel a fluid in response to a first force that can occur while driving the electrified vehicle. The second drainage tube is configured to expel the fluid in response to a second force that can occur while driving the electrified vehicle.

In a further non-limiting embodiment of the foregoing electrified vehicle, the first force is a force associated with acceleration of the electrified vehicle, and the second force is a force associated with deceleration of the electrified vehicle.

In a further non-limiting embodiment of either of the foregoing electrified vehicles, the first force is a force associated with turning the electrified vehicle in a first direction, and the second force is a force associated with turning the electrified vehicle in a second, opposite direction.

In a further non-limiting embodiment of any of the foregoing electrified vehicles, the first drainage tube and the second drainage tube extend along axes that are parallel to a length of the first frame rail and the second frame rail.

In a further non-limiting embodiment of any of the foregoing electrified vehicles, the first drainage tube and the second drainage tube extend along axes that are transverse to a length of the first frame rail and the second frame rail.

In a further non-limiting embodiment of any of the foregoing electrified vehicles, the exterior surface is part of an enclosure tray of the enclosure assembly. The first drainage tube is configured to interface with the interior via a first drain provided within a floor of the enclosure tray, and the second drainage tube is configured to interface with the interior via a second drain provided within the floor.

In a further non-limiting embodiment of any of the foregoing electrified vehicles, the first drainage tube includes at least one opening that aligns with the first drain to allow the fluid to drain into the first drainage tube from the interior, and the second drainage tube includes at least one opening that aligns with the second drain to allow the fluid to drain into the second drainage tube from the interior.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle that includes a traction battery pack.

FIG. 2 is a side view of a traction battery pack of an electrified vehicle.

FIG. 3 illustrates an exemplary check valve of a drainage tube of a traction battery pack water drainage system.

FIG. 4 illustrates another exemplary check valve of a drainage tube of a traction battery pack water drainage system.

FIG. 5 illustrates yet another exemplary check valve of a drainage tube of a traction battery pack water drainage system.

FIG. 6 illustrates an exemplary water drainage system for a traction battery pack of an electrified vehicle.

FIG. 7 illustrates another exemplary water drainage system for a traction battery pack of an electrified vehicle.

FIG. 8 illustrates another exemplary water drainage system for a traction battery pack of an electrified vehicle.

FIG. 9 illustrates another exemplary water drainage system for a traction battery pack of an electrified vehicle.

FIG. 10 illustrates yet another exemplary water drainage system for a traction battery pack of an electrified vehicle.

### DETAILED DESCRIPTION

This disclosure details systems and methods for draining fluids (e.g., water and/or other fluids) from a traction battery pack. An exemplary water drainage system for a traction battery pack may include one or more drainage tubes. Each drainage tube may be configured to release water from the tube in response to forces that naturally occur while driving an electrified vehicle that is equipped with the traction battery pack. Water may enter the drainage tubes through a drain provided in an enclosure tray of the traction battery pack. These and other features are discussed in greater detail in the following paragraphs of this detailed description.

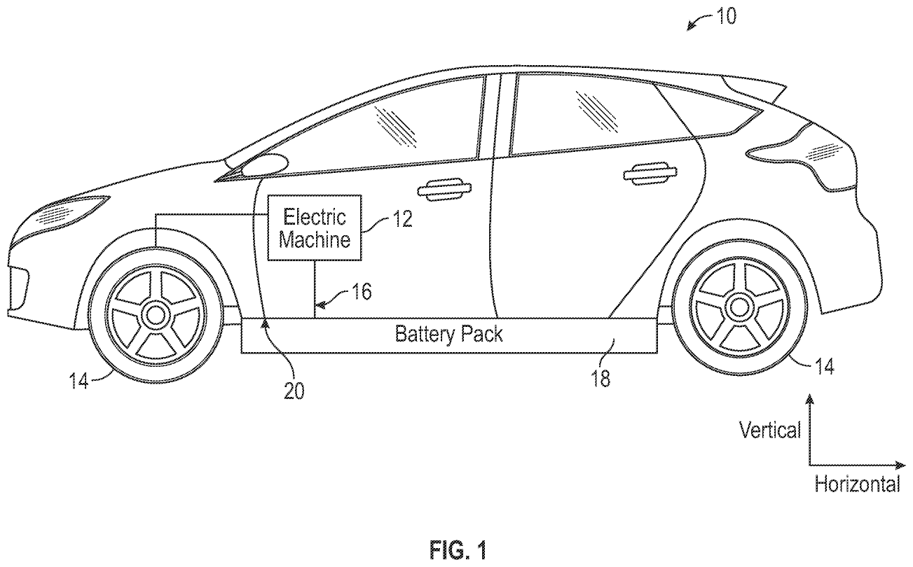

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

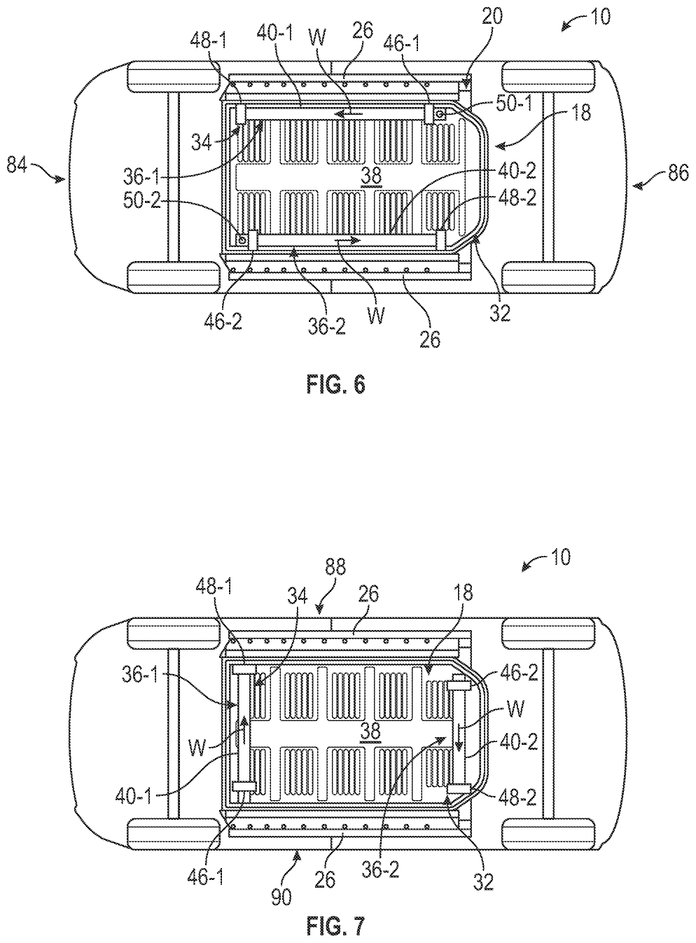

The traction battery pack 18 may be secured to an underbody 20 of the electrified vehicle 10. In an embodiment, the traction battery pack 18 is mounted between a pair of longitudinally extending frame rails 26 of the underbody 20 (see FIG. 6). However, the traction battery pack 18 could be mounted elsewhere on the electrified vehicle 10 within the scope of this disclosure.

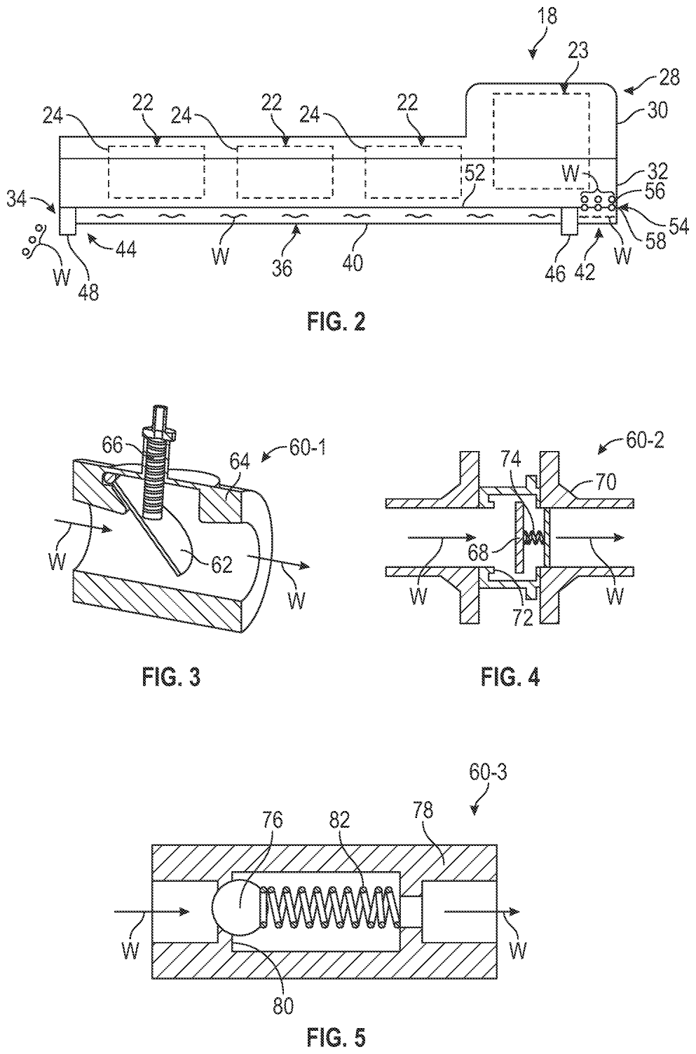

FIG. 2 illustrates additional details associated with the traction battery pack 18 of the electrified vehicle 10. The traction battery pack 18 may include one or more battery arrays 22 (e.g., battery assemblies/modules or groupings of rechargeable battery cells 24) capable of outputting electrical power to power the electric machine 12 and/or other electrical loads of the electrified vehicle 10.

The battery cells 24 may be stacked side-by-side along a stack axis to construct a grouping of battery cells 24, sometimes referred to as a “cell stack.” The total number of battery arrays 22 and battery cells 24 provided within the traction battery pack 18 is not intended to limit this disclosure.

In an embodiment, the battery cells 24 of each battery array 22 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The battery arrays 22 and various other battery internal components 23 (e.g., bussed electrical center, battery electric control module, wiring, connectors, etc.) may be housed inside of an enclosure assembly 28. The enclosure assembly 28 may include an enclosure cover 30 and an enclosure tray 32 that establish outermost surfaces of the traction battery pack 18. The enclosure cover 30 may be secured (e.g., bolted, welded, adhered, etc.) to the enclosure tray 32 to provide a sealed interior. The size, shape, and overall configuration of the enclosure assembly 28 is not intended to limit this disclosure.

Water W can sometimes enter the traction battery pack 18 through various infiltration points (e.g., through missing or punctured vent patch, through cracks formed in the enclosure tray 32 or the enclosure cover 30, etc.) and can accumulate within a basin of the enclosure tray 32. If not removed, the water W can cause corrosion and isolation faults in the battery arrays 22 and battery internal components 23 that housed within the sealed interior of the enclosure assembly 28.

The traction battery pack 18 may therefore be equipped with a water drainage system 34 that is configured for periodically draining the water W and/or other fluids from the sealed interior of the traction battery pack 18. Advantageously, the water drainage system 34 does not require electronics or removal of any parts in order to continuously eliminate the fluids that have accumulated inside the traction battery pack 18.

The water drainage system 34 may include one or more drainage tubes 36 that are arranged to interface with the enclosure tray 32 of the enclosure assembly 28 of the traction battery pack 18. Each drainage tube 36 may be mounted to an exterior surface 38 (see FIG. 6) of the enclosure tray 32 or could be integrally formed (e.g., molded) into the enclosure tray 32. The exterior surface 38 is a bottom surface of the enclosure tray 32 that faces toward the ground in an ordinary orientation of the electrified vehicle 10 during operation.

The drainage tube 36 may include a tubular body 40 that extends between a first end portion 42 and a second end portion 44. A first or inlet check valve 46 may be provided at the first end portion 42, and a second or outlet check valve 48 may be provided at the second end portion 44. As further detailed below, the inlet check valve 46 may be configured to control the flow of the water W into the tubular body 40, and the outlet check valve 48 may be configured to control the release of the water W from the tubular body 40 in response to forces that naturally occur while driving the electrified vehicle 10. The water W may accumulate within the tubular body 40 prior to being periodically expelled from the drainage tube 36 through the outlet check valve 48, such as during changes in vehicle velocity that can occur during acceleration, deceleration, turning, or braking of the electrified vehicle 10, for example.

The water W may enter the drainage tube 36 through one or more drains 50 provided in a floor 52 of the enclosure tray 32. The drain 50 may be provided near a corner 54 of the enclosure tray 32 or at any other suitable location of the enclosure tray 32, such as a low spot, for example. In an embodiment, each drain 50 may include one or more holes 56 formed through the floor 52. In another embodiment, cach drain 50 may be configured as a French drain style water collection system that is formed or otherwise provided within the floor 52. The drainage tube 36 may include one or more openings 58 that are arranged to align with the holes 56 of the drain 50 for allowing the water W to drain down into the first end portion 42 of the drainage tube 36.

The inlet check valve 46 may be a one-way valve that prevents backflow of the water W once it has entered the tubular body 40. The inlet check valve 46 may be a flapper valve, a spring valve, a spring-ball valve, or any other type of check valve.

The outlet check valve 48 may also be a one-way valve that prevents backflow of the water W once it has exited from the tubular body 40. The outlet check valve 48 may be a flapper valve, a spring valve, a spring-ball valve, or any other type of check valve.

FIG. 3 illustrates an exemplary check valve 60-1. The check valve 60-1 is an example of a spring flapper style check valve that may be used as the inlet check valve 46, the outlet check valve 48, or both. The check valve 60-1 may include a flapper 62 that is configured to rotate inside a housing 64. The flapper 62 may be biased toward a closed position by a spring 66 to prevent fluid flow through the housing 64. When a head pressure of the water W exceeds a biasing force of the spring 66, the flapper 62 may pivot to allow the water W to pass through the check valve 60-1.

FIG. 4 illustrates another exemplary check valve 60-2. The check valve 60-2 is an example of a spring valve style check valve that may be used as the inlet check valve 46, the outlet check valve 48, or both. The check valve 60-2 may include a disk 68 that is configured to translate within a housing 70. The disk 68 may be biased toward a seated position against a seating surface 72 of the housing 70 by a spring 74 to prevent fluid flow through the housing 70. When a head pressure of the water W exceeds a biasing force of the spring 74, the disk 68 may be displaced from the seating surface 72 to allow the water W to pass through the check valve 60-2.

FIG. 5 illustrates another exemplary check valve 60-3. The check valve 60-3 is an example of a spring-ball style check valve that may be used as the inlet check valve 46, the outlet check valve 48, or both. The check valve 60-3 may include a ball 76 that is configured to translate within a housing 78. The ball 76 may be biased toward a seated position against a seating surface 80 of the housing 78 by a spring 82 to prevent fluid flow through the housing 70. When a head pressure of the water W exceeds a biasing force of the spring 82, the ball 76 may be displaced away from the seating surface 80 to allow the water W to pass through the check valve 60-3.

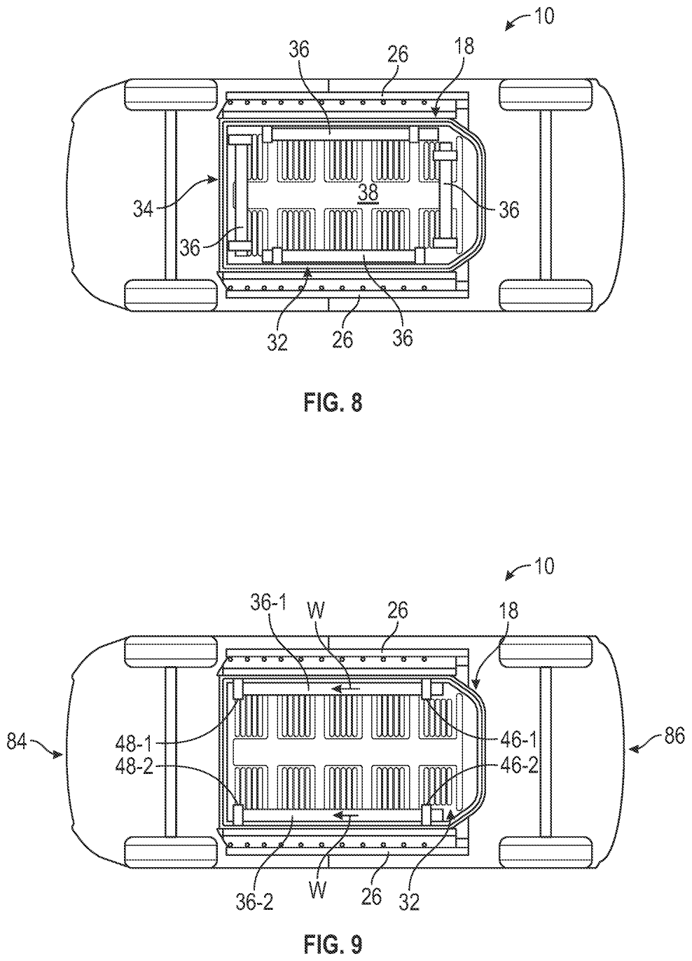

Referring now to FIG. 6, with continued reference to FIGS. 1-2, the water drainage system 34 may include a first drainage tube 36-1 and a second drainage tube 36-2. The first drainage tube 36-1 and the second drainage tube 36-2 may be mounted near opposite sides of the enclosure tray 32 of the traction battery pack 18 and may be arranged to extend in parallel with the frame rails 26. The first drainage tube 36-1 and the second drainage tube 36-2 may therefore extend in a lengthwise direction of the electrified vehicle 10. In another embodiment, the first drainage tube 36-1 and the second drainage tube 36-2 may be arranged to extend laterally in a cross-vehicle direction of the electrified vehicle 10 (see FIG. 7). In yet another embodiment, the water drainage system 34 may include drainage tubes 36 that are arranged to extend in both the longitudinal and the lateral cross-vehicle directions of the electrified vehicle 10 (see FIG. 8).

The placement and orientation of the first drainage tube 36-1 and the second drainage tube 36-2 can affect the manner in which water W is released from the drainage tubes of the water drainage system 34. For example, the first drainage tube 36-1 may be arranged such that an outlet check valve 48-1 of the first drainage tube 36-1 is closer to a front end 84 of the electrified vehicle 10 compared to an inlet check valve 46-1, and the second drainage tube 36-2 may be arranged such that an outlet check valve 48-2 of the second drainage tube 36-2 is closer to a rear end 86 of the electrified vehicle 10 compared to an inlet check valve 46-2. In such a configuration, the outlet check valves 48-1, 48-2 are positioned near opposite ends of the enclosure tray 32.

In this exemplary configuration, water W may drain down into the first drainage tube 36-1 (e.g., through drain 50-1) when the electrified vehicle 10 is accelerating and may enter through the inlet check valve 46-1 and exit through the outlet check valve 48-1 when the electrified vehicle is decelerating, and water W may drain down into the second drainage tube 36-2 (e.g., through drain 50-2) when the electrified vehicle 10 is decelerating and may enter through the inlet check valve 46-2 and exit through the outlet check valve 48-2 when the electrified vehicle is accelerating. In this way, the water drainage system 34 may be configured to expel water W from the traction battery pack 18 during both acceleration and deceleration forces that can occur while driving the electrified vehicle 10.

As the electrified vehicle 10 accelerates while driving in the rearward direction or decelerates while driving in the forward direction, such as during a braking condition, the water W may slosh within the tubular body 40-1 in a direction toward the outlet check valve 48-1 of the first drainage tube 36-1. The water W may therefore slosh to the left (toward the front end 84) in the configuration of FIG. 6 to increase the head pressure of the fluid. When the head pressure exceeds the biasing force of the outlet check valve 48-1, the water W may be released from the first drainage tube 36-1 to the outside.

As the electrified vehicle 10 accelerates while driving in the forward direction or decelerates while driving in the rearward direction, such as during a braking condition, the water W may slosh within the tubular body 40-2 in a direction toward the outlet check valve 48-2 of the second drainage tube 36-2. The water W may therefore slosh to the right (toward the rear end 86) in the configuration of FIG. 6 to increase the head pressure of the fluid. When the head pressure exceeds the biasing force of the outlet check valve 48-2, the water W may be released from the second drainage tube 36-2 to the outside.

As alluded to above, various other configurations of the water drainage system 34 are contemplated within the scope of this disclosure. In the configuration of FIG. 7, for example, the drainage tubes 36-1, 36-2 may be configured to release the water W in response to forces that are incurred when the electrified vehicle 10 is turning. As the electrified vehicle 10 turns right, the water W may slosh within the tubular body 40-1 toward the outlet check valve 48-1 of the first drainage tube 36-1. The water W may therefore slosh toward the top the page (toward a driver side 88) in the configuration of FIG. 7 to increase the head pressure of the fluid. When the head pressure exceeds the biasing force of the outlet check valve 48-1, the water W may be released from the first drainage tube 36-1 to the outside.

Moreover, as the electrified vehicle 10 turns left, the water W may slosh within the tubular body 40-2 toward the outlet check valve 48-2 of the second drainage tube 36-2. The water W may therefore slosh toward the bottom of the page (toward a passenger side 90) in the configuration of FIG. 7 to increase the head pressure of the fluid. When the head pressure exceeds the biasing force of the outlet check valve 48-2, the water W may be released from the second drainage tube 36-2 to the outside

In the configuration of FIG. 9, the first drainage tube 36-1 may be arranged such that an outlet check valve 48-1 of the first drainage tube 36-1 is closer to the front end 84 of the electrified vehicle 10 compared to an inlet check valve 46-1, and the second drainage tube 36-2 may also be arranged such that an outlet check valve 48-2 of the second drainage tube 36-2 is closer to the front end 84 of the electrified vehicle 10 compared to an inlet check valve 46-2. In such a configuration, the outlet check valves 48-1, 48-2 are positioned near the same end of the enclosure tray 32. Thus, water W can be released from both the first drainage tube 36-1 and the second drainage tube 36-2 during the same vehicle conditions (e.g., when accelerating while driving in the rearward direction or decelerating while driving in the forward direction).

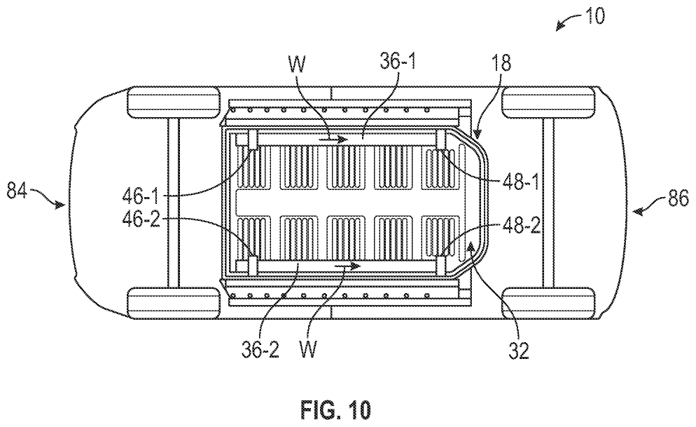

In the configuration of FIG. 10, the first drainage tube 36-1 may be arranged such that an outlet check valve 48-1 of the first drainage tube 36-1 is closer to the rear end 86 of the electrified vehicle 10 compared to an inlet check valve 46-1, and the second drainage tube 36-2 may also be arranged such that an outlet check valve 48-2 of the second drainage tube 36-2 is closer to the rear end 86 of the electrified vehicle 10 compared to an inlet check valve 46-2. In such a configuration, the outlet check valves 48-1, 48-2 are positioned near the same end of the enclosure tray 32. Thus, water W can be released from both the first drainage tube 36-1 and the second drainage tube 36-2 during the same vehicle conditions (e.g., when accelerating while driving in the forward direction or decelerating while driving in the rearward direction).

The exemplary traction battery packs of this disclosure include water drainage systems that are capable of draining fluids from the traction battery pack without any required electronics or the need to remove parts (i.e., drain plugs). The proposed systems further improve customer satisfaction by substantially eliminating the need to trigger malfunction indictor lights and reducing repair costs.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
an enclosure assembly including an enclosure cover and an enclosure tray that cooperate to establish an interior;
a battery array positioned within the interior; and
a water drainage system including a first drainage tube mounted to or formed as part of the enclosure tray, wherein the first drainage tube is configured to drain a fluid from the interior to a location outside of the traction battery pack.

2. The traction battery pack as recited in claim 1, wherein the fluid includes water.

3. The traction battery pack as recited in claim 1, wherein the first drainage tube is configured to interface with the interior via a drain provided within a floor of the enclosure tray.

4. The traction battery pack as recited in claim 3, wherein the drain includes at least one hole formed through the floor.

5. The traction battery pack as recited in claim 4, wherein the first drainage tube includes at least one opening that aligns with the at least one hole to allow the fluid to drain into the first drainage tube.

6. The traction battery pack as recited in claim 1, wherein the first drainage tube includes an first inlet check valve, a first outlet check valve, and a first tubular body extending between the first inlet check valve and the first outlet check valve.

7. The traction battery pack as recited in claim 6, comprising a second drainage tube mounted to or formed within the enclosure tray and including a second inlet check valve, a second outlet check valve, and a second tubular body extending between the second inlet check valve and the second outlet check valve.

8. The traction battery pack as recited in claim 7, wherein the first drainage tube and the second drainage tube are arranged such that the first outlet check valve and the second outlet check valve are positioned near opposite ends or sides of the enclosure tray.

9. The traction battery pack as recited in claim 7, wherein the first drainage tube and the second drainage tube are arranged such that the first outlet check valve and the second outlet check valve are positioned near a common end or side of the enclosure tray.

10. The traction battery pack as recited in claim 6, wherein the first outlet check valve is a flapper valve.

11. The traction battery pack as recited in claim 6, wherein the first outlet check valve is a spring valve.

12. The traction battery pack as recited in claim 6, wherein the first outlet check valve is a spring-ball valve.

13. The traction battery pack as recited in claim 1, wherein the first drainage tube is configured to expel the fluid to the location outside of the traction battery pack in response to a force associated with a velocity change.

14. An electrified vehicle, comprising:
an underbody including a first frame rail and a second frame rail; and
a traction battery pack mounted between the first frame rail and the second frame rail and including an enclosure assembly that establishes an interior, a first drainage tube arranged at an exterior surface of the enclosure assembly, and a second drainage tube arranged at the exterior surface,
wherein the first drainage tube is configured to expel a fluid in response to a first force that can occur while driving the electrified vehicle,
wherein the second drainage tube is configured to expel the fluid in response to a second force that can occur while driving the electrified vehicle.

15. The electrified vehicle as recited in claim 14, wherein the first force is a force associated with acceleration of the electrified vehicle, and the second force is a force associated with deceleration of the electrified vehicle.

16. The electrified vehicle as recited in claim 14, wherein the first force is a force associated with turning the electrified vehicle in a first direction, and the second force is a force associated with turning the electrified vehicle in a second, opposite direction.

17. The electrified vehicle as recited in claim 14, wherein the first drainage tube and the second drainage tube extend along axes that are parallel to a length of the first frame rail and the second frame rail.

18. The electrified vehicle as recited in claim 14, wherein the first drainage tube and the second drainage tube extend along axes that are transverse to a length of the first frame rail and the second frame rail.

19. The electrified vehicle as recited in claim 14, wherein the exterior surface is part of an enclosure tray of the enclosure assembly, and further wherein the first drainage tube is configured to interface with the interior via a first drain provided within a floor of the enclosure tray, and the second drainage tube is configured to interface with the interior via a second drain provided within the floor.

20. The electrified vehicle as recited in claim 19, wherein the first drainage tube includes at least one opening that aligns with the first drain to allow the fluid to drain into the first drainage tube from the interior, and the second drainage tube includes at least one opening that aligns with the second drain to allow the fluid to drain into the second drainage tube from the interior.
